(19) United States
(12) Patent Application Publication
(10) Pub. No.: US 2005/0237950 A1
(43) Pub. Date: Oct. 27, 2005

(54) System, method and apparatus for dynamic path protection in networks

(75) Inventors: Shengli Yuan, Frisco, TX (US); Jason P. Jue, Richardson, TX (US)

Correspondence Address: CHALKER FLORES, LLP, 12700 PARK CENTRAL, STE. 455, DALLAS, TX, 75251, US

(73) Assignee: Board of Regents, The University of Texas System, Austin, TX (US)

(21) Appl. No.: 11/114,564

(22) Filed: Apr. 25, 2005

Related U.S. Application Data
(60) Provisional application No. 60/565,334, filed on Apr. 26, 2004.

(51) Int. Cl. H04L 12/28; H04L 12/26; H04J 3/14; H04J 1/16; H04L 1/00

(52) U.S. Cl. 370/255; 370/225; 370/248

(57) ABSTRACT

The present invention provides a system, method and apparatus for dynamic path protection in networks by finding two paths between a source node and a destination node in a network having multiple nodes and multiple links. A first path is found between the source node and the destination node using a routing algorithm and a model of the network. Each link has a cost and at least one risk identifier. The cost of the links having one or more risk identifiers that occur more than once in the network model are increased. The model is modified by removing all links in the first path and all links having one or more risk identifiers in common with any of the risk identifiers of the links in the first path. The second path is found between the source node and the destination node using the routing algorithm and the modified model.

### FIELD OF THE INVENTION

The present invention relates generally to the field of communications and, more particularly, to a system, method and apparatus for dynamic path protection in networks.

### BACKGROUND OF THE INVENTION

The rapid growth of the Internet and the World Wide Web are demanding more bandwidth from network carriers, pushing them to deploy high speed networks that use wavelength division multiplexing (“WDM”). A wavelength routed WDM network enables end users to communicate with one another via all-optical WDM channels that may span multiple nodes and fiber links. Such all-optical channels are referred to as lightpaths.

Once an end-to-end path is established, a node or a fiber link failure may lead to the failure of all lightpaths that traverse that failed node or fiber link. Since the aggregate data rate on a single WDM fiber link can be as high as 50 Tbps, a failure may potentially lead to the loss of a large amount of data. To minimize the data loss, appropriate protection and restoration schemes are needed.

In protection schemes, backup resources are pre-computed and reserved for each connection before a failure occurs. In restoration schemes, a route and free wavelength are discovered dynamically for each interrupted connection after a failure occurs. A restoration scheme is usually more resource efficient, while a protection scheme has a faster recovery time and provides guaranteed recovery ability.

Protection schemes can be divided into two categories based on the level of network resource involved in the protection. These two categories are path protection and link protection. In path protection, two disjoint paths are established for each connection: a working path and a protection path. Under normal operation, user traffic is carried on the working path, but in the case of a failure on the working path, the traffic is switched to the pre-reserved protection path. In link protection, separate backup resources are reserved for each individual link on the working path. When a link fails, the traffic is rerouted only around the failed link. Path protection usually has lower resource requirements and lower end-to-end propagation delay for the recovered route, while link protection can provide faster recovery since no end-to-end signaling is required.

Protection schemes can be further divided into two categories based on whether backup resources are shared by more than one connection. The first category is dedicated protection. In this type of protection, no sharing of backup resources is allowed; thus each link or node can be reserved as a backup resource for at most one connection. The second category is shared protection. In this type of protection, a link or node can be reserved as a backup resource for multiple connections, as long as those connections do not fail simultaneously. Dedicated protection requires more network resources but less signaling and management, while shared protection is more resource efficient but requires complex singling and management.

Current protection scheme methods fail to address the fact that a single risk factor can cause multiple links to fail simultaneously. Moreover, the algorithms used in current protection scheme methods often fail to identify valid disjoint paths from some network topologies, even though such paths exist. There is, therefore, a need for a system, method and apparatus that provides dynamic path protection in all network topologies using risk-disjoint paths.

### SUMMARY OF THE INVENTION

Path protection requires finding a working path and a protection path that are link disjoint. The present invention considers two problems on dynamic path protection in WDM mesh networks. In the first problem, a network without wavelength converters is considered; thus both the working path and protection path are subject to the wavelength continuity constraint. Existing polynomial time algorithms can be applied to find a pair of link-disjoint lightpaths on a single wavelength; however, such algorithms fail if the working and protection lightpaths are on two different wavelengths. In the second problem, a network with full wavelength conversion is considered; thus the wavelength continuity constraint does not apply. Yet a single risk factor can cause multiple links to fail simultaneously. The problem becomes finding link-disjoint lightpaths that are also risk disjoint. The present invention proves that both of the two problems are NP-complete. ILP formulations for the two NP-complete problems are given, as well as heuristic algorithms. Computer simulations have been conducted to evaluate the performance of the heuristic algorithms.

More specifically, the present invention provides a method for finding two paths between a source node and a destination node in a network having multiple nodes and multiple links. A first path is found between the source node and the destination node using a routing algorithm and a model of the network. Each link has a cost and at least one risk identifier. The cost of the links having one or more risk identifiers that occur more than once in the network model are increased. The network model is modified by removing all links in the first path and all links having one or more risk identifiers in common with any of the risk identifiers of the links in the first path. A second path is then found between the source node and the destination node using the routing algorithm and the modified network model.

The present invention can be invoked in response to a connection request containing the source node and the destination node such that the present invention provides the first path as a working path and the second path as a protection path. Likewise, the present invention can be invoked in response to a restoration request containing the source node, the destination and a failed path such that the present invention sets the failed path as the first path and provides the second path a restoration path. In addition, the routing algorithms used by present invention may include Dijkstra's shortest path algorithm, Suurballe's disjoint paths algorithm and/or combinations and variation thereof. For example, the present invention may use: (1) Suurballe's disjoint paths algorithm or a variation thereof to find two paths, the shorter of which is chosen as the first path; and (2) Dijkstra's shortest path algorithm or a variation thereof to find the second path.

In another example, the present invention may use: (1) Suurballe's disjoint paths algorithm or a variation thereof to find two paths, the shorter of which is chosen as the first path and the longer of which is chosen as a third path; and (2) Dijkstra's shortest path algorithm or a variation thereof to find the second path. Thereafter, a total cost for the first path and the second path are calculated, the network model is modified by removing all links in the third path and all links having one or more risk identifiers in common with any of the risk identifiers of the links in the third path, a fourth path between the source node and the destination node is found using Dijkstra's shortest path algorithm or a variation thereof, and a total cost for the third path and the fourth path is calculated. The first path is provided as a working path and the second path is provided as a protection path whenever the total cost of the first path and the second path is less than or equal to the total cost of the third path and the fourth path. The third path is provided as the working path and the fourth path is provided as the protection path whenever the total cost of the first path and the second path is greater than the total cost of the third path and the fourth path.

The present invention can be used in any network, such as a computer network, a communications network, an electrical circuit, an electrical network, a logistics network or a pipeline network. Communications networks may include a mesh network, a ring network, an ATM network, an IP network, a MPLS network or an optical network. In addition, the present invention can embodied in a computer program embodied on a computer readable medium for finding two paths between a source node and a destination node in a network having multiple nodes and multiple links wherein each step is implemented as one or more code segments.

Furthermore, the present invention provides an apparatus for finding two paths between a source node and a destination node in a network having multiple nodes and multiple links that includes a processor and one or more communication interfaces communicably coupled to the processor that are capable of communicating with the network. The processor is capable of finding a first path between the source node and the destination node using a routing algorithm and a model of the network wherein each link has a cost and at least one risk identifier and the cost of the links having one or more risk identifiers that occur more than once in the network model are increased, modifying the network model by removing all links in the first path and all links having one or more risk identifiers in common with any of the risk identifiers of the links in the first path, and finding a second path between the source node and the destination node using the routing algorithm and the modified network model.

The present invention also provides a system having one or more networks having multiple nodes and multiple links, a source node and a destination node within the one or more networks, a processor and one or more communication interfaces communicably coupled to the processor that are capable of communicating with the one or more networks. The processor finds a first path between the source node and the destination node using a routing algorithm and a model of the one or more networks. Each link has a cost and at least one risk identifier. The cost of the links having one or more risk identifiers that occur more than once in the network model are increased. The network model is modified by removing all links in the first path and all links having one or more risk identifiers in common with any of the risk identifiers of the links in the first path. A second path is found between the source node and the destination node using the routing algorithm and the modified network model.

Other features and advantages of the present invention will be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings, in which:

FIG. 1 depicts a single-wavelength WDM network wherein the numbers indicate link costs;

FIG. 2 depicts a two-wavelength WDM network with only one pair of disjoint paths;

FIG. 3 depicts a bridge configuration;

FIG. 4 depicts a graph constructed from a 3SAT instance;

FIG. 5 depicts an example of Risk ID, Risk Set and the risk-disjoint constraint wherein the numbers indicate Risk Ids of each link in accordance with one embodiment of the present invention;

FIG. 6 depicts a flow chart of a method in accordance with one embodiment of the present invention;

FIG. 7 depicts a flow chart of a method in accordance with another embodiment of the present invention;

FIG. 8 depicts a flow chart of a method in accordance with another embodiment of the present invention;

FIGS. 9A and 9B depict flow charts of a method in accordance with another embodiment of the present invention;

FIG. 10 depicts a block diagram of a system in accordance with one embodiment of the present invention;

FIG. 11 depicts a 16 node NSFNET backbone network wherein the numbers indicate Risk IDs in accordance with another embodiment of the present invention;

FIG. 12 depicts a graph of blocking probability versus load for the Route-First algorithm and the Wavelength-Scan algorithm under high loads in accordance with one embodiment of the present invention;

FIG. 13 depicts a graph of blocking probability versus load for the Route-First algorithm and the Wavelength-Scan algorithm under low loads in accordance with one embodiment of the present invention; and

FIG. 14 depicts a graph of blocking probability versus load for the Simple Two-Step algorithm and the Modified Two-Step algorithm under low loads in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. For example, although the description of the present invention focuses on dedicated path protection, the inventon taught herein can be easily applied to shared path protection.

Path protection requires finding a working path and a protection path that are link disjoint. The present invention considers two problems on dynamic path protection in WDM mesh networks. In the first problem, a network without wavelength converters is considered; thus both the working path and protection path are subject to the wavelength continuity constraint. Existing polynomial time algorithms can be applied to find a pair of link-disjoint lightpaths on a single wavelength; however, such algorithms fail if the working and protection lightpaths are on two different wavelengths. In the second problem, a network with full wavelength conversion is considered; thus the wavelength continuity constraint does not apply. Yet a single risk factor can cause multiple links to fail simultaneously. The problem becomes finding link-disjoint lightpaths that are also risk disjoint. The present invention proves that both of the two problems are NP-complete. Integer Linear Programming (“ILP”) formulations for the two NP-complete problems are given, as well as heuristic algorithms. Computer simulations have been conducted to evaluate the performance of the heuristic algorithms.

The dedicated path protection problem can be considered under either static or dynamic traffic. Under static traffic, the set of connection requests is known in advance. The working and protection paths for each connection request must be routed, and a wavelength must be assigned for each path. The related problem of finding disjoint paths for a collection of k source-destination pairs is NP-complete. The problem can be formulated using ILP and can be solved through heuristic algorithms. Under dynamic traffic, connection requests arrive one at a time and each connection exists for only a finite duration, referred to as the connection holding time. Subsequently, routing the working path and protection path is done individually for each connection request. The following description of the present invention will consider dynamic traffic.

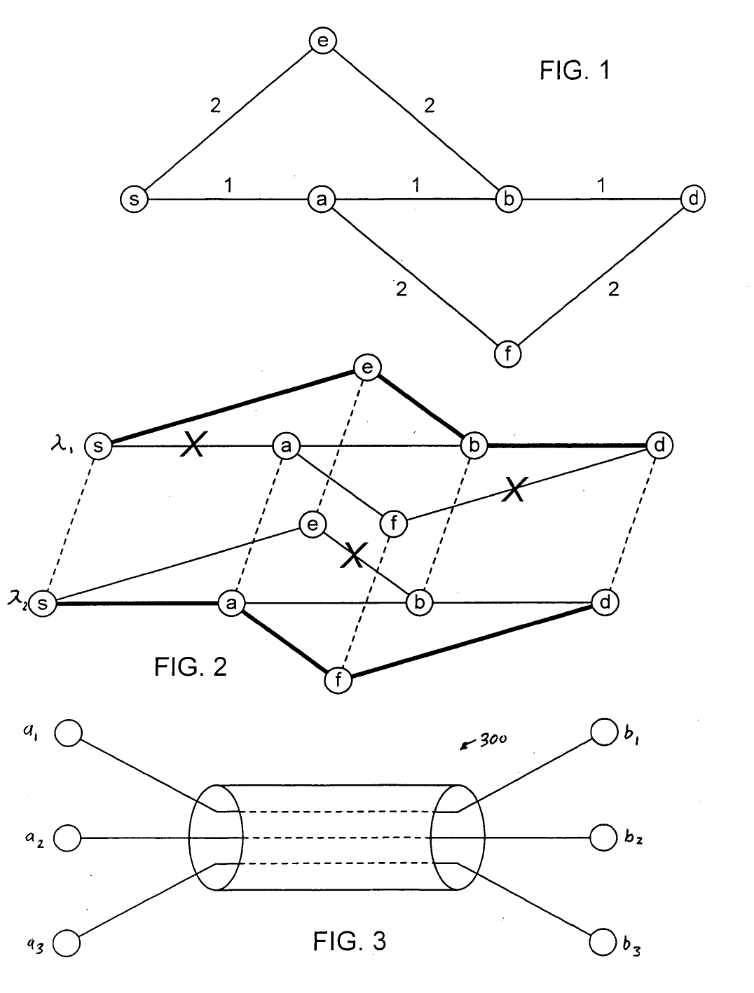

In an optical network without wavelength conversion capability, the dynamic establishment of a working lightpath and its protection lightpath is subject to the wavelength continuity constraint, i.e., a lightpath is required to be on the same wavelength channel throughout its entire path in the network. The working path and its protection path may both be on the same wavelength, or each may be on a different wavelength. The two lighpaths can be found intuitively using a simple two-step solution. In this approach, the first step is to find the shortest path from the source to the destination, and to let this path be the working path. The second step is to remove all links on the working path and to find another shortest path from the source to the destination. If the second path is found, it is guaranteed to be link disjoint from the working path, and it is designated as the protection path. However, this two-step solution may not yield valid disjoint paths for some network topologies, even though the paths do exist. An example of such a single-wavelength WDM network is depicted in FIG. 1 wherein the circles containing letters indicate network nodes (s, a, b, c, d, e and f), the lines between the circles indicate network links (s-a, s-e, a-b, a-f, b-e, b-d and f-d) and the numbers adjacent to the network links indicate link costs (e.g., 1 for link s-a, 2 for link s-e, etc.). This network has only one wavelength. The simple two-step solution finds the first shortest path from source node s to destination node d along lightpath s-a-b-d but fails to find a second link disjoint lightpath, even though two link-disjoint paths exist (s-e-b-d and s-a-f-d).

For single-wavelength networks, a feasible solution can be found using Suurballe's algorithm and its variations. The total cost of the resulting two link-disjoint lightpaths is minimal among all such path pairs. The algorithm runs in O(n²log n) time, where n is the number of nodes. For networks with multiple wavelengths, this algorithm can be applied on every wavelength in order to find a pair of link-disjoint paths from the source to the destination on the same wavelength. However, if such paths do not exist on the same wavelength, Suurballe's algorithm may fail. For example, FIG. 2 depicts a two-wavelength (λ₁, λ₂) WDM network with only one pair of disjoint paths (the two sets of thick solid lines) from s to d, each on a different wavelength. As with FIG. 1, the circles containing letters indicate network nodes (s, a, b, c, d, e and f) and the lines between the circles indicate network links (sa, se, ab, af, be, bd and fd). Wavelength λ₁ is unavailable on links sa and fd, and wavelength λ₂ is unavailable on link eb (denoted by the X on each unavailable link). Now the problem is to find two link-disjoint paths on two different wavelengths. The link disjoint path for wavelength λ₁ is s-e-b-d and the link disjoint path for wavelength λ₂ is s-a-f-d. The problem is NP-complete for the special case in which the total cost of the two lightpaths is to be minimal. The present invention proves that in a more general case, the problem is still NP-complete for both dedicated protection and shared protection, regardless of the path costs.

Now consider the dedicated path protection problem in a WDM network with full wavelength conversion capability at every optical switch. The wavelength conversion capability eliminates the wavelength continuity constraint on lightpaths, and Suurballe's algorithm can now be applied to find a working path and its link disjoint protection path. However, these two paths may still fail simultaneously if a single factor can cause more than one fiber link or node in the network to fail, and if those links and nodes happen to be on both the working and protection lightpaths.

In a special case of this type of network configuration, multiple fiber links are bundled into the same underground conduit, or span. Even though these fiber links are disjoint in the network layer, a cut to the underground conduit can cause all the fiber links to fail. To describe this type of network configuration, transport network carriers use the notation of Shared Risk Link Group (“SRLG”). Those fiber links in the same conduit belong to the same SRLG because they all share the same risk factor of a conduit cut. In order for path protection to work, all the fiber links on a protection path must be in different SRLGs from those links on the working path. Therefore, in addition to being link disjoint, the protection routing problem in this type of network has the extra constraint of being SRLG disjoint or risk disjoint.

Large networks may contain several hundred SRLGs. Finding link disjoint paths with the additional SRLG-disjoint constraint is therefore more complex than finding merely link disjoint paths. For some special SRLG configurations, such as forks and express links, there still exist algorithms with polynomial time complexity. These algorithms use graph transformations techniques such that the special SRLG configuration can be treated as regular links and nodes. Yet when the configurations are arbitrary, algorithms with polynomial time complexity have not been found. For instance, in a so-called “bridge” configuration as shown in FIG. 3, m (m>1) fiber links share the same span; thus, the fibers are in the same SRLG 300. As shown, the same SRLG 300 contains three parallel fiber links (a₁b₁, a₂b₂ and a₃b₃). Trying to find two SRLG disjoint paths in a network containing such a configuration is likely to have O(2^{m}) complexity.

The concept of SRLG also applies to WDM wavelength-routed networks where the same risk factor may take down multiple lightpaths. The present invention uses the notations of Risk ID and Risk Set for describing risk distributions in general connection-oriented networks. For dedicated protection, if the risks are arbitrarily distributed, the problem of finding two risk-disjoint lightpaths is NP-complete. The NP-completeness for shared protection. As described below, simpler proofs for both dedicated protection and shared protection based on the NP-completeness proof of the first problem under the wavelength continuity constraint are provided.

Several heuristic techniques that address the Routing and Wavelength Assignment (“RWA”) problem of lightpath protection can be applied to the first problem. K alternate link-disjoint routes are predefined for each s-d pair. When a connection request arrives, all wavelengths on the K routes are examined until a pair of link-disjoint lightpaths with the minimal total cost is found. Two groups of alternate shortest routes are predefined for each s-d pair: M routes for the working path and B routes for the protection path. Routes within the same group are not necessarily link-disjoint from each other, but a route in one group will be link disjoint from all routes in the other group. When a connection request arrives, all routes in the working-path group are searched until a route is found with a free wavelength on the entire route. Similarly, all routes in the protection-path group are searched until an available route is found. Since the set of working and protection routes is predefined, the heuristic is not guaranteed to find a set of link-disjoint routes, even if such routes exist.

For the path protection problem under the risk-disjoint constraint, heuristics use the simple two-step approach. These heuristics assign a higher cost to links with Risk IDs that occur more frequently in the network, so that such links are less likely to be selected by a working path. As a result, it is more likely that a risk-disjoint protection path can be found. A heuristic is proposed for the special case of path protection under the duct-layer constraint. The heuristic first applies Suurballe's algorithm in the duct layer to find two duct-disjoint paths, then assigns free fiber links to the paths. As described below, heuristic algorithms are developed for the general case of the problem in which risks are arbitrarily distributed in the network.

The present invention finds a working lightpath and its protection lightpath under the wavelength continuity constraint. This problem is NP-complete if the two lightpaths are on different wavelengths, regardless of the path costs. The proof is then extended to show that the problem of finding a working lightpath and its protection lightpath under the risk-disjoint constraint is also NP-complete if the risks are arbitrarily distributed.

In WDM networks, if the optical switches do not have wavelength conversion capability, lightpaths are subject to the wavelength continuity constraint, i.e., a lightpath is required to be on the same wavelength channel throughout its entire path in the network. This constraint applies to the establishments of both the working lightpath and the protection lightpath. Suurballe's algorithm can be used to determine whether a working lightpath and its protection lightpath exist on a single wavelength. If the algorithm fails, then two link-disjoint lightpaths need to be found, each on a different wavelength. As shown below, this problem is NP-complete.

The proof of NP-Completeness for Dedicated Protection is formally defined as follows. Given optical network G=(N, L), where N is the set of optical switching nodes and L is the set of fiber links, and given the number of wavelengths on each fiber link, find two link disjoint paths from source node s to destination node d such that each path is on a different wavelength.

The 3SAT problem, which is known to be NP-complete, is reduced to the target problem. The 3SAT problem is stated as follows. Given a collection C={C₁, C₂, . . . , C_{M}} of clauses on a finite set V={v₁, v₂, . . . , v_{N}} of variables such that |Cⱼ|=3 for 1≦j≦M, where clause Cⱼ is the boolean “or” of three literals (a literal is either a variable or the boolean “not” of a variable) and is satisfied by a truth assignment if and only if at least one of the three literals is true, is there a truth assignment for V that satisfies all the clauses in C?

A graph G is constructed for an arbitrary instance of 3SAT C, such that the graph contains two link-disjoint paths, P₁ on wavelength λ₁ and P₂ on wavelength λ₂, from node s to node d if and only if there is a truth assignment satisfying all clauses. In this proof, the graph contains only two wavelengths, λ₁ and λ₂, but it can easily be expanded to the case of more wavelengths. The steps for the graph construction are:
1. Create source node s and destination node d.
2. Corresponding to the N variables in V, create n+1 nodes zᵢ, 0≦i≦N. There is a link from s to z₀ and from z_{N} to d. Between zᵢ₋₁ and zᵢ, there are nodes xᵢ¹, yᵢ¹, xᵢ², yᵢ², . . . , xᵢ^{M}, xᵢ^{M}, and \overline{x}ᵢ¹, \overline{y}ᵢ¹, \overline{x}ᵢ², \overline{y}ᵢ², . . . , \overline{x}ᵢ^{M}, \overline{y}ᵢ^{M}, which correspond to the M clauses in C. There are links zᵢ₋₁xᵢ¹, xᵢ¹yᵢ¹, yᵢ¹xᵢ², xᵢ²yᵢ², . . . , xᵢ^{M}yᵢ^{M}, yᵢ^{M}zᵢ and links zᵢ₋₁\overline{x}ᵢ¹, \overline{x}ᵢ¹\overline{y}ᵢ¹, \overline{y}ᵢ¹\overline{x}ᵢ², \overline{x}ᵢ²\overline{y}ᵢ², . . . , \overline{x}ᵢ^{M}\overline{y}ᵢ^{M}, \overline{y}ᵢ^{M}zᵢ. Links xᵢ^{j}yᵢ^{j} and \overline{x}ᵢ^{j}\overline{y}ᵢ^{j} each contain two wavelengths, λ₁ and λ₂. All other links created in this step contain only wavelength λ₁.
3. Corresponding to each clause Cⱼ, create nodes uⱼ and wⱼ, 1≦j≦M. There is a link from s to u₁ and from w_{M} to d. There is also a link from wⱼ to uⱼ₊₁. Other links are formed according to the following rules:
   a. A link from uⱼ to xᵢ^{j} exists, and a link from yᵢ^{j} to wⱼ exists, if and only if variable vᵢ is in clause Cⱼ.
   b. A link from uⱼ to \overline{x}ᵢ^{j} exists, and a link from \overline{y}ᵢ^{j} to wⱼ exists, if and only if variable \overline{v}ᵢ is in clause Cⱼ.

All links constructed in this step only contain wavelength λ₂.

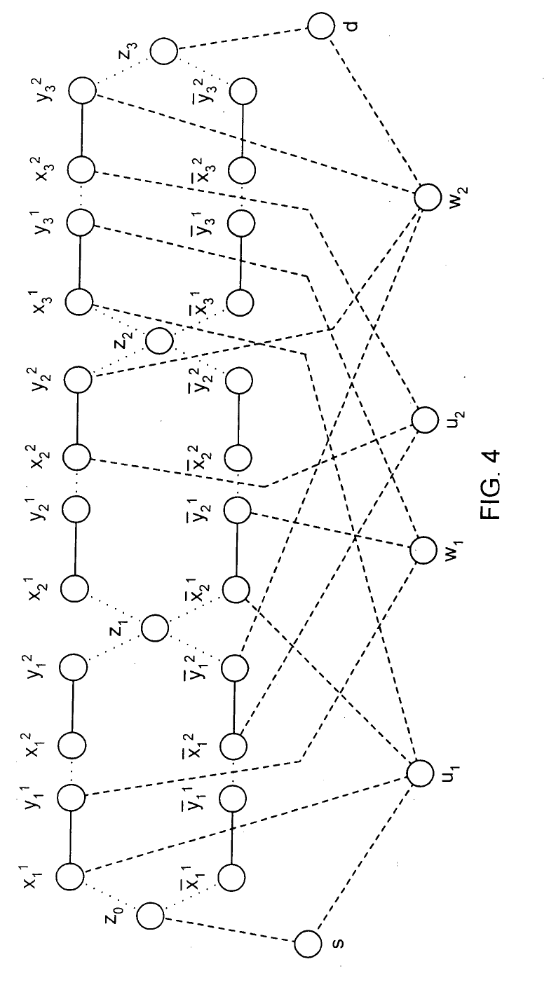

An example is given in FIG. 4 wherein a graph G is constructed for a 3SAT instance C={C₁, C₂}, V={v₁, v₂, v₃}, C₁=v₁ [symbol] \overline{v}₂ [symbol] v₃, C₂=\overline{v}₁ [symbol] v₂ [symbol] v₃. The dotted links contain wavelength λ₁ and the dashed links contain wavelength λ₂. The solid links contain both wavelengths λ₁ and λ₂. For a truth assignment v₁=1, v₂=1, v₃=1, the corresponding disjoint paths are: P₁ (s−z₀−\overline{x}₁¹−\overline{y}₁¹−\overline{x}₁²−\overline{y}₁²−z₁−\overline{x}₂¹−\overline{y}₂¹−\overline{x}₂²−\overline{y}₂²−z₂−\overline{x}₃¹−\overline{y}₃¹−\overline{x}₃²−\overline{y}₃²−z₃−d) on wavelength λ₁ and P₂ (s−u₁−x₁¹−y₁¹−w₁−u₂−x₂²−y₂²−w₂−d) on wavelength λ₂.

Lemma 1: If C is satisfiable, then there exist two disjoint paths of different wavelengths from node s to node d in graph G.

Proof: Let boolean values be assigned to v₁, v₂, . . . , v_{N} that satisfy C. The two paths should be routed as follows:
P₁ is on wavelength λ₁. It traverses all zᵢ nodes for 0≦i≦N. Between node zᵢ₋₁ and zᵢ, the path is routed via nodes xᵢ^{j} and yᵢ^{j} (1≦j≦M) if and only if vᵢ=0. Otherwise it is routed via nodes \overline{x}ᵢ^{j} and \overline{y}ᵢ^{j}.
P₂ is on wavelength λ₂. It traverses all uⱼ, wⱼ nodes for 1≦j≦M. Between node uⱼ and wⱼ, the path is routed as follows. By construction, link uⱼwⱼ corresponds to clause Cⱼ which has three literals. Each of the literals corresponds to a path from uⱼ to wⱼ that goes either through nodes xᵢ^{j} and yᵢ^{j} if the literal is in the form of vⱼ, or through nodes \overline{x}ᵢ^{j} and \overline{y}ᵢ^{j} if the literal is in the negation form, \overline{v}ⱼ.

Because C is satisfied, at least one of the three literals in Cⱼ must be 1. Let the variable in that true literal be vⱼ. Then
if the literal is in the form of vⱼ, then vⱼ=1, and route P₂ passes through nodes xᵢ^{j}, yᵢ^{j};
if the literal is in the form of \overline{v}ⱼ, then vⱼ=0, and route P₂ passes through nodes \overline{x}ᵢ^{j}, \overline{y}ᵢ^{j}.

If more than one literal is true, then one of the true literals is randomly picked and P2 is routed accordingly.

Thus, P1 doesn't traverse any of the nodes uⱼ, wⱼ for 1≦j≦M, and P₂ doesn't traverse any of the nodes zᵢ for 0≦i≦N. Furthermore, if P₂ traverses node xᵢ^{j}, yᵢ^{j}, then P₁ traverses \overline{x}ᵢ^{j}, \overline{y}ᵢ^{j}, and vice versa. Therefore P₁ and P₂ are link disjoint, and each is on a different wavelength.

Lemma 2: If there exist two link-disjoint paths of different wavelengths from s to d in the constructed graph G, then C can be satisfied.

Proof:
1. Since there are only two links originating from the source node s, the two links must each belong to a separate path. Let sz₀ be part of P₁ and su₁ be part of P₂.
2. Since P₂ is already on wavelength λ₂, P₁ must not traverse any of the nodes uⱼ, wⱼ nodes for 1≦j≦M, otherwise it would also be on wavelength λ₂ and violate the wavelength continuity constraint. Therefore, if P₁ traverses xᵢ¹ for 1≦i≦N, then it must also traverse yᵢ¹, xᵢ², yᵢ², . . . , xᵢ^{M}, yᵢ^{M}, zᵢ. Similarly if P₁ traverses \overline{x}ᵢ¹ for 1≦i≦N, then it must also traverse, \overline{y}ᵢ¹, \overline{x}ᵢ², \overline{y}ᵢ², . . . , \overline{x}ᵢ^{M}, \overline{y}ᵢ^{M}, zᵢ.
3. Since P₁ is already on wavelength λ₁, P₂ must not traverse any of the nodes zᵢ for 0≦i≦N, otherwise it would also be on wavelength λ₁ and violate the wavelength continuity constraint. Furthermore, if P₂ traverses node uⱼ (1≦j≦M) and xᵢ^{j} (1≦i≦N), it must also traverse yᵢ¹ and then back to wⱼ. Similarly, if P₂ traverses node uⱼ and \overline{x}ᵢ^{j}, it must also traverse \overline{y}ᵢ^{j} and then back to wⱼ.
4. Loops are not allowed. Therefore once P₂ reaches wⱼ (1≦j≦M), it must go to uᵢ₊₁ if j<M, or to d if j=M.
5. If P₂ traverses nodes xᵢ^{j}, yᵢ^{j}, 1≦j≦M, 1≦i≦N, it must not also traverse nodes \overline{x}ᵢ^{k} and \overline{y}ᵢ^{k}, k≠j, and vice versa; otherwise P₁ is “blocked” and cannot reach the destination node d without violating the link disjoint constraint.

6. If P₂ traverses nodes xᵢ^{j}, yᵢ^{j}, 1≦j≦M, 1≦i≦N, then P₁ must traverses nodes traverses \overline{x}ᵢ¹ for 1≦i≦N, then it must also traverse \overline{x}ᵢ¹, \overline{y}ᵢ¹, \overline{x}ᵢ², \overline{y}ᵢ², . . . , \overline{x}ᵢ^{j}, \overline{y}ᵢ^{j}, . . . , \overline{x}ᵢ^{M}, \overline{y}ᵢ^{M}. Similarly if P₂ traverses nodes \overline{x}ᵢ^{j}, \overline{y}ᵢ^{j}, then P₁ must traverses nodes xᵢ¹, yᵢ¹, xᵢ², yᵢ², . . . , xᵢ^{j}, yᵢ^{j}, . . . , xᵢ^{m}, yᵢ^{m}.
7. Assign values to v₁, v₂, . . . , v_{N} as follows:
   If P₂ traverses nodes xᵢ^{j}, yᵢ^{j}, 1≦j<M, 1≦i≦N then assign vᵢ=1, making clause Cⱼ to be true.
   If P₂ traverses nodes \overline{x}ᵢ^{j}, \overline{y}ᵢ^{j}, 1≦j≦M, 1≦i≦N, then assign vᵢ=0, making clause Cⱼ to be true.
   Variables that are not assigned a value in the first two steps are randomly assigned either 1 or 0.
   This assignment satisfies C.

Combining Lemma 1 and Lemma 2, the 3SAT problem is reducible to the problem of finding disjoint lightpaths on different wavelengths. Therefore this problem is NP-complete, regardless of the paths costs. Since the problem with dedicated protection is a special case of that with shared protection, the problem with shared protection is also NP-complete.

An ILP formulation for the dynamic path protection problem under the wavelength continuity constraint will now be described. Since the traffic is dynamic, the ILP formulation should be solved for each incoming connection request when Suurballe's algorithm fails to find a working lightpath and its protection lightpath on a single wavelength. There are two objectives here. One objective is to find any two link-disjoint lightpaths. An alternative objective is to minimize the total hop count of the two lightpaths.

The following are given as inputs to the problem.
N: number of nodes in the network
L: collection of all fiber links in the network.
Λᵢⱼ: collection of all free wavelengths on fiber link ij∈L. Λᵢⱼ is empty if all wavelengths on link ij are already taken by previously established lightpaths.
W: the maximum number of wavelengths on any fiber link.
s: source node
d: destination node

The ILP solves for the following variables.
αᵢⱼ^{sdw}: 1 if wavelength w on link ij is taken by the working lightpath from source s to destination d; 0 otherwise.
βᵢⱼ^{sdw}: 1 if wavelength w on link ij is taken by the working lightpath from source s to destination d; 0 otherwise.

Objective: Find a working lightpath and a protection lightpath that satisfy the wavelength continuity constraint.

$${\sum }_{∀ ij ∈ L} {\sum }_{∀ w ∈ {⋀}_{ij}} {α}_{ij}^{sdw} + {\sum }_{∀ ij ∈ L} {\sum }_{∀ w ∈ {⋀}_{ij}} {β}_{ij}^{sdw} > 0 \qquad ( 1 )$$

Alternative Objective: Minimize the total hop count of the working lightpath and its protection lightpath.

$$Minimize ( {\sum }_{∀ ij ∈ L} {\sum }_{∀ w ∈ {⋀}_{ij}} {α}_{ij}^{sdw} + {\sum }_{∀ ij ∈ L} {\sum }_{∀ w ∈ {⋀}_{ij}} {β}_{ij}^{sdw} > 0 ) \qquad ( 2 )$$

Subject to:

Flow-conservation under the wavelength continuity constraint:

$$\begin{matrix}{\sum }_{i = 1}^{N} {α}_{lj}^{sdw} - {\sum }_{j = 1}^{N} {α}_{lj}^{sdw} = \{ \begin{matrix}1 , & if l = d \\ - 1 , & if l = s \\ 0 & otherwise\end{matrix} \\ 1 \leq l \leq N , 1 \leq w \leq W , & ( 3 ) \\ {\sum }_{i = 1}^{N} {β}_{lj}^{sdw} - {\sum }_{j = 1}^{N} {β}_{lj}^{sdw} = \{ \begin{matrix}1 , & if l = d \\ - 1 , & if l = s \\ 0 & otherwise\end{matrix} \\ 1 \leq l \leq N , 1 \leq w \leq W , & ( 4 )\end{matrix}$$

Link disjoint constraint:

$${\sum }_{∀ w ∈ {⋀}_{ij}} {α}_{ij}^{sdw} + {\sum }_{∀ w ∈ {⋀}_{ij}} {β}_{ij}^{sdw} \leq 1 , ∀ ij ∈ L \qquad ( 5 )$$

Two heuristic algorithms for finding link-disjoint lightpaths in WDM networks will now be described. The first algorithm is named the Route-First algorithm. In this algorithm, a standard routing and wavelength assignment (“RWA”) approach is used. The present invention first tries to find two disjoint routes, and then attempts to assign free wavelengths to them. The second algorithm is named the Wavelength-Scan algorithm. In this algorithm, each wavelength is scanned for a pair of link-disjoint paths using Suurballe's algorithm. If Surballe's algorithm fails, each pair of wavelengths is scanned for a pair of links-disjoint paths on different wavelength using a two-step approach.

The details of the algorithms are as follows. The Route-First algorithm follows three steps:
1. Scan all links and increase the cost of a link linearly to the number of wavelengths already in use on the link. This step increases the success rate in Step 3.
2. Run Suurballe's algorithm and obtain two minimum cost link disjoint routes from the source to the destination.
3. Assign a free wavelength to each of the two routes if a free wavelength is available on the entire route. The wavelength assignment is done using the First-Fit scheme, i.e., assign the first free wavelength found to a lightpath. Other wavelength assignment schemes can be used, such as Best-Fit or Minimum-Load.

A connection request is blocked if Surrballe's algorithm fails to find two disjoint routes, or if there are no free wavelengths on either route. The running time is O(n²log n+Wn), where n is the number of nodes and W is the number of wavelengths in the network. The pseudo code is as follows:

```
for ( all network links)
{
//Increase cost cₗ on link l according to n_{f}, the number of
wavelengths in use on l.
cₗ = cₗ + f(nₗ);
}
//Searching for two link disjoint routes from s to d
if ( Suurballe's algorithm(s, d) fails )
return(failure);
else //Found two routes r₁ and r₂
{
  for ( all wavelengths λᵢ and λᵢ in the network and λᵢ ≠ λᵢ )
  {
  if ( a wavelength λᵢ is available on route r₁ and a wavelength λᵢ
is available on route r₂ )
    {
    assign λᵢ to r₁ and make it the working lightpath p₁;
    assign λᵢ to r₂ and make it the protection lightpath p₂;
    return(p₁ and p₂);
    }
  }
return(failure);
}
```

In the Wavelength-Scan algorithm, the present invention first attempts to find the working lightpath and the protection lightpath on a single wavelength. For each wavelength in the network, Surrballe's algorithm is run and a pair of link disjoint lightpaths is obtained. The total cost of the lightpath pairs on each wavelength is compared and the wavelength for which the pair of lightpaths has the least cost is chosen. If Suurballe's algorithm fails to find two link-disjoint paths on a single wavelength, then the simple two-step algorithm is invoked. It runs Dijkstra's shortest path algorithm on all wavelengths, searching for a lightpaths from the source to destination. If that lightpath is found, the algorithm removes all links on the lightpath and run Dijkstra's algorithm again on all wavelengths until the second shortest path is found. The pseudo code is as follows:

```
total_cost = INFINITY;
working_path = NULL;
protection_path = NULL;
for ( all the wavelengths )
{
if (Suurballe's algorithm(s, d) succeeds )
  {
  //Found two link disjoint lightpaths p₁ and p₂ from s to d
  combined_cost = cost of p₁ + cost of p₂
  if ( total_cost > combined_cost )
    {
    total_cost = combined_cost;
    working_path = p₁;
    protection_path = p₂;
    }
  }
}
if ( working_path ≠ NULL and protection_path ≠ NULL )
return( working_path, and protection_path );
//If the previous step fails
for ( all wavelength λᵢ in the network )
{
//Searching for the first shortest path p₁ from s to d
if ( Dijkstra's algorithm(s, d) on λᵢ fails )
  continue;
else
  {
  for ( all λᵢ in the network and λᵢ ≠ λᵢ )
    {
    remove links on the first shortest path;
    //Searching for the second shortest path p₂
    if ( Dijkstra's algorithm(s, d) on λᵢ fails )
      continue;
    else
      return(p₁ and p₂ ); //Return the lightpaths
    }
    continue; //Search for a new pair
  }
}
return(failure);
```

This algorithm has a running time of O(W·n²log n), where n is the number of nodes and W is the number of wavelengths in the network.

Comparing the two algorithms, the Route-First algorithm obtains the routes first before it assigns free wavelengths to the routes. If the algorithm returns successfully, the total cost of the two lightpaths is minimal among all link-disjoint paths from s to d. On the other hand, the Wavelength-Scan algorithm scans through all available wavelengths, searching for the two link-disjoint paths, first on a single wavelength then on different wavelengths. Thus the running time of the second algorithm is higher. When the traffic load is low, the Route-First algorithm should have lower blocking probabilities because free wavelengths are readily available and the routes are optimal in total cost. When the traffic load is high, the Wavelength-Scan algorithm should have lower blocking probability because it searches through all available wavelengths. To obtain the benefits of both approaches, the two algorithms can be combined by attempting the Wavelength-Scan algorithm if the Route-First algorithm fails.

As previously discussed, in a WDM network that has no wavelength conversion capability, the problem of routing a working path and its protection path, each on a different wavelength, is NP-complete. A WDM network that has wavelength converters at every node will now be considered. In such a network, Suurballe's algorithm can be used to find two link-disjoint lightpaths. But if the same risk factor can cause multiple links to fail simultaneously, then a working lightpath and its protection lghtpath may still fail simultaneously even if they are link disjoint. Therefore, the working path and protection path must be not only link disjoint but also risk disjoint. It has been speculated that this problem is NP-complete if the risks are arbitrarily distributed. As described below, problem is indeed NP-complete.

The problem is formally defined as follows. Given network G=(N, L), where N is the set of nodes and L is the set of links, and given the SRLGs in G and their distribution, find two risk-disjoint paths from source node s to destination node d. Once again 3SAT is reduced to the risk-disjoint paths routing problem. The proof is nearly identical to the one described above. The difference is on how links are assigned to different SRLGs in graph G. The graph construction procedure is as follows:

For an instance of 3 SAT,
1. Create source node s and destination node d;
2. Corresponding to the N variables in V, create n+1 nodes zᵢ, 0≦i≦N. There is a link from s to z₀ and from z_{N} to d. Between zᵢ₋₁ and zᵢ, there are nodes xᵢ¹, yᵢ¹, xᵢ², yᵢ², . . . , xᵢ^{M}, xᵢ^{M}, and \overline{x}ᵢ¹, \overline{y}ᵢ¹, \overline{x}ᵢ², \overline{y}ᵢ², . . . , \overline{x}ᵢ^{M}, \overline{y}ᵢ^{M}, which correspond to the M clauses in C. There are links zᵢ₋₁xᵢ¹, xᵢ¹yᵢ¹, yᵢ¹xᵢ², xᵢ²yᵢ², . . . , xᵢ^{M}yᵢ^{M}, yᵢ^{M}zᵢ and links zᵢ₋₁\overline{x}ᵢ¹, \overline{x}ᵢ¹\overline{y}ᵢ¹, \overline{y}ᵢ¹\overline{x}ᵢ², \overline{x}ᵢ²\overline{y}ᵢ², . . . , \overline{x}ᵢ^{M}\overline{y}ᵢ^{M}, \overline{y}ᵢ^{M}zᵢ. Links xᵢ^{j}yᵢ^{j} and \overline{x}ᵢ^{j}\overline{y}ᵢ^{j} each belongs to their own SRLG other than SRLG 1 and SRLG 2. All other links created in this step belong to SRLG 1.
3. Corresponding to each clause Cⱼ, create nodes uⱼ and wⱼ, 1≦j≦M. There is a link from s to u₁ and from w_{M} to d. There is also a link from wⱼ to uⱼ₊₁. Other links are formed according to the following rules:
   A link from uⱼ to xᵢ^{j} exists, and a link from yᵢ^{j} to wⱼ exists, if and only if variable vᵢ is in clause Cⱼ.
   A link from uⱼ to \overline{x}ᵢ^{j} exists, and a link from \overline{y}ᵢ^{j} to wⱼ exists, if and only if variable \overline{v}ᵢ is in clause Cⱼ.
   All links constructed in this step belong to SRLG 2.

The rest of proof is the same as that described above. It can be proved that there exist two risk-disjoint paths from node s to node d in graph G if and only if there is a truth assignment to satisfy C. Therefore the problem of finding two risk disjoint paths is NP-complete, regardless of the paths costs. The same proof can be applied to prove the problem is also NP-complete in shared path protection.

The concept of SRLG is primarily used by transport network carries to describe the risk sharing by fiber links bundled in a common conduit, or span. The risk-disjoint constraint is applicable to other connection-oriented networks as well. In order to extend the results of this to general connection-oriented networks, the present invention uses the following concepts:
Risk ID: For each risk factor that may cause a failure in a network, an unique integer number called the Risk ID is assigned. If a network resource, such as a link or a node, is subjected to the risk of one or more failures, then the collection of Risk IDs on that network resource describe all the factors that may cause the resource to fail.
Risk Set: A path may traverse multiple network links and nodes. The collection of Risk IDs of the links and nodes is called the Risk Set of the path. The Risk Set represents all the factors that may cause a path to fail. The working path and its protection path must be risk disjoint. In other words, the Risk Sets of the two paths must contain no common Risk IDs.

The concepts of Risk ID and Risk Set are a generalization of SRLG. A single Risk ID represents a SRLG in an optical transport network. In an abstract manner, the concept of Risk ID and Risk Set describes the risks in a network and their associations with network resources, thus it facilitates the implementation of routing algorithms and ILP formulations for path protection. If at least one unique Risk ID is assigned to each link (and node), then risk-disjoint paths are also link disjoint.

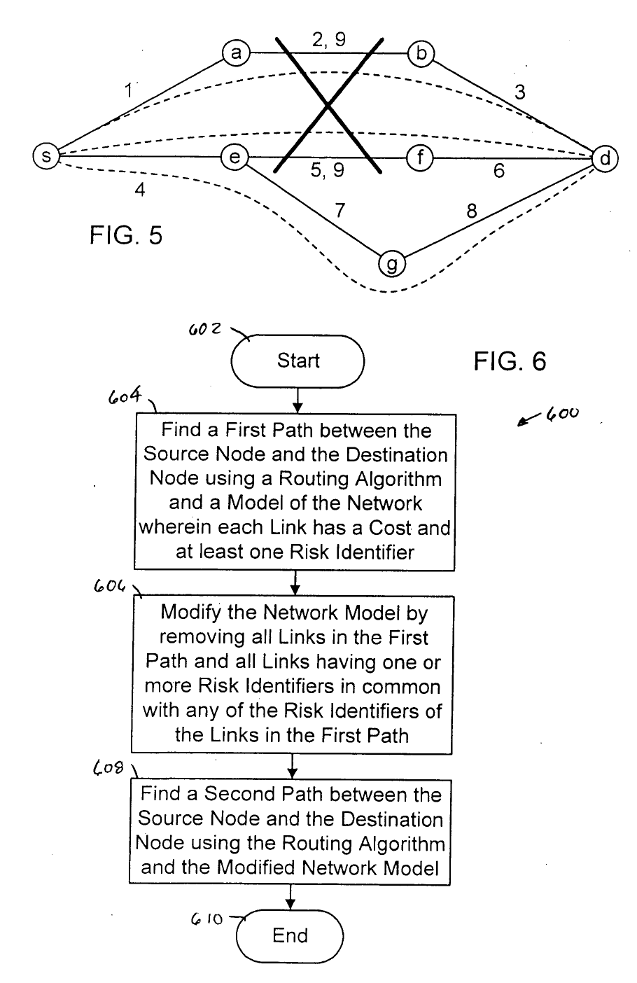

To illustrate these concepts, assume that in a connection-oriented network, such as a WDM wavelength-routed network shown in FIG. 5, which depicts an example of Risk ID, Risk Set and the risk-disjoint constraint wherein the numbers indicate Risk IDs of each link. As shown, there are seven nodes (s, a, b, d, e, f and g) and eight fiber links (sa, se, ab, bd, ef, eg, fd and gd). The problem is to find a working path and its protection path from node s to node d. To solve the problem, a unique Risk ID is assigned to each link (sa=1, se=4, ab=2, bd=3, ef=5, eg=7, fd=6 and gd=8). In this case, fiber links ab and ef cross the same bridge and thus are susceptible to the same risk of a bridge collapse. Therefore a Risk ID 9 is assigned to both links, so Risk Ids for link a-b=2, 9 and e-f=5, 9.

Now consider path sabd and sefd. The first path has Risk Set {1, 2, 3, 9} and the second path has a Risk Set {4, 5, 6, 9}. Since the two sets contain common Risk ID 9, they are not risk disjoint and can not be assigned as the working and protection paths. Next, paths sabd and segd are considered. The first path still has Risk Set {1, 2, 3, 9} while the second one now has a Risk Set {4, 7, 8}, thus they are risk disjoint. Since each physical fiber link has been assigned at least one unique Risk ID, the two paths are also link-disjoint.

By using Risk IDs and Risk Sets, the problem of dynamic routing of working and protection paths in a general connection-oriented network can be defined as follows. Given network G=(N, L), where N is the set of nodes and L is the set of links, and given the Risk IDs of each node and link, find two risk-disjoint paths from source node s to destination node d. The proof can be easily generalized to prove that this problem is NP-complete.

The following discussion of the present invention provides an ILP formulation is developed for the dynamic path protection problem under the risk-disjoint constraint. Since the traffic is dynamic, the ILP formulation should be solved for each incoming connection request. There are two objectives here. One objective is to find any two risk-disjoint lightpaths. An alternative objective is to minimize the total hop count of the two lightpaths. The following are given as inputs to the problem.
N: number of nodes in the network.
L: collection of all links in the network.
Wᵢⱼ: number of free wavelengths on link ij∈L; Wᵢⱼ takes on the value of 0 if all wavelengths are taken by previously established lightpaths.

S={s₁, s₂, . . . , sₖ, . . . , s_{T}}: collection of all Risk Ids in the network. T is the number of Risk IDs in the network.
rᵢⱼ^{k}: 1 if link ij has Risk ID sₖ; 0 otherwise.
s: source node.
d: destination node.

The ILP solves the following variables.
αᵢⱼ^{sdw}: 1 if wavelength w on link ij is taken by the working lightpath from source s to destination d; 0 otherwise.
βᵢⱼ^{sdw}: 1 if wavelength w on link ij is taken by the working lightpath from source s to destination d; 0 otherwise.

Objective: Find a working lightpath and a protection lightpath that satisfy the risk-disjoint constraint.

$${\sum }_{∀ ij ∈ L} {{\sum }_{w}}^{{W}_{ij}} {α}_{ij}^{sdw} + {\sum }_{∀ ij ∈ L} {{\sum }_{w}}^{{W}_{ij}} {β}_{ij}^{sdw} > 0 \qquad ( 6 )$$

Alternative Objective: Minimize the total hop count of the working lightpath and its protection lightpath.

$$Minimize ( {\sum }_{∀ ij ∈ L} {{\sum }_{w}}^{{W}_{ij}} {α}_{ij}^{sdw} + {\sum }_{∀ ij ∈ L} {{\sum }_{w}}^{{W}_{ij}} {β}_{ij}^{sdw} ) \qquad ( 7 )$$

Subject to:

Flow-conservation without the wavelength continuity constraint:

$$\begin{matrix}{\sum }_{i = 1}^{N} {{\sum }_{w}}^{{W}_{ij}} {α}_{lj}^{sdw} - {\sum }_{j = 1}^{N} {\sum }_{w}^{{W}_{ij}} {α}_{lj}^{sdw} = \{ \begin{matrix}1 , & if l = d \\ - 1 , & if l = s \\ 0 & otherwise\end{matrix} \\ 1 \leq l \leq N , 1 \leq w \leq W , & ( 8 ) \\ {\sum }_{i = 1}^{N} {\sum }_{w}^{{W}_{ij}} {β}_{lj}^{sdw} - {\sum }_{j = 1}^{N} {\sum }_{w}^{{W}_{ij}} {β}_{lj}^{sdw} = \{ \begin{matrix}1 , & if l = d \\ - 1 , & if l = s \\ 0 & otherwise\end{matrix} \\ 1 \leq l \leq N , 1 \leq w \leq W , & ( 9 )\end{matrix}$$

Link disjoint constraint:

$${\sum }_{w}^{{W}_{ij}} {α}_{ij}^{sdw} + {\sum }_{w}^{{W}_{ij}} {β}_{ij}^{sdw} \leq 1 , 1 \leq i , j \leq N$$

Risk-disjoint constraint:
∀k≦T, ∀ij∈L, ∀mn∈L (11)

As a result of the previously described proofs and as depicted in FIG. 6, the present invention provides a method 600 for finding two paths between a source node and a destination node in a network having multiple nodes and multiple links. The process 600 starts in block 602 and a first path is found between the source node and the destination node using a routing algorithm and a model of the network in block 604. Each link has a cost and at least one risk identifier. The cost of the links having one or more risk identifiers that occur more than once in the network model are increased. The network model is modified by removing all links in the first path and all links having one or more risk identifiers in common with any of the risk identifiers of the links in the first path in block 606. A second path is then found between the source node and the destination node using the routing algorithm and the modified network model in block 608 and the process ends in block 610.

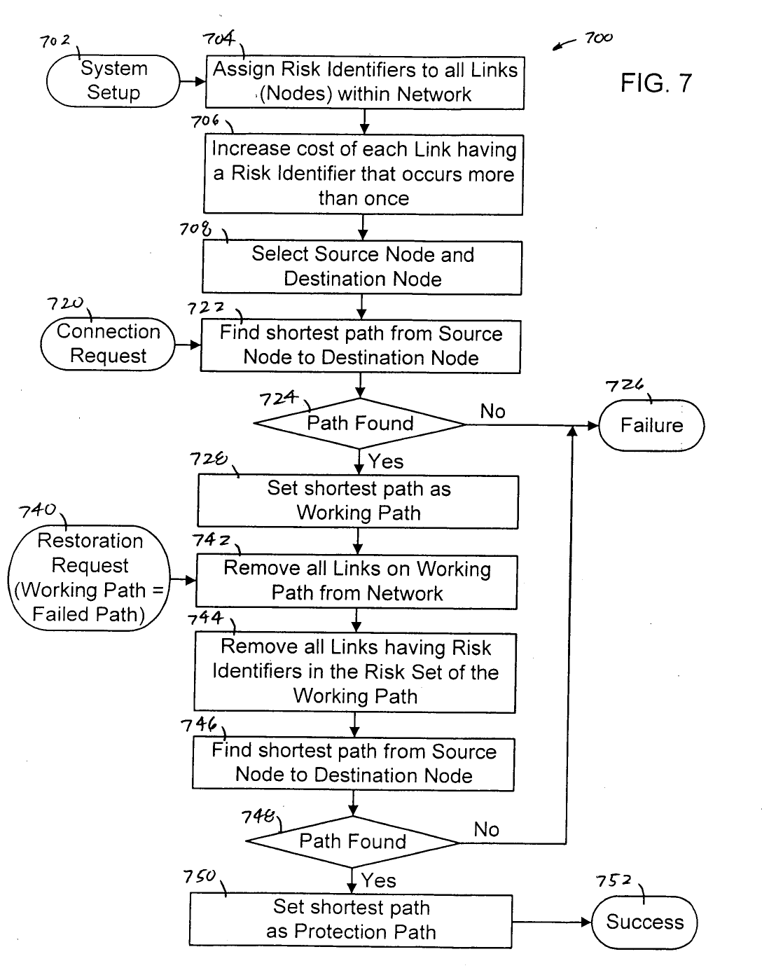

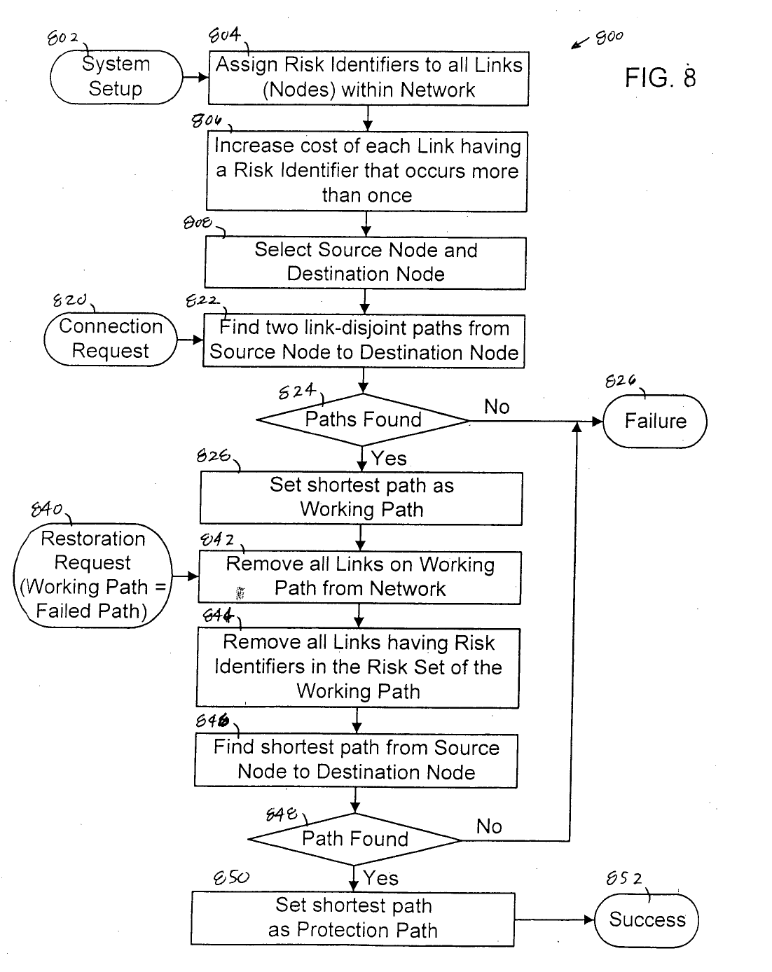

The present invention can be invoked in response to a connection request containing the source node and the destination node such that the present invention provides the first path as a working path and the second path as a protection path. Likewise, the present invention can be invoked in response to a restoration request containing the source node, the destination and a failed path such that the present invention sets the failed path as the first path and provides the second path a restoration path. In addition, the routing algorithms used by present invention may include Dijkstra's shortest path algorithm, Suurballe's disjoint paths algorithm and/or combinations and variation thereof. For example, one embodiment of the present invention (FIG. 7) uses Dijkstra's shortest path algorithm or a variation thereof as the routing algorithm to find the first path and second path. In another example, one embodiment of the present invention (FIG. 8) uses: (1) Suurballe's disjoint paths algorithm or a variation thereof to find two paths, the shorter of which is chosen as the first path; and (2) Dijkstra's shortest path algorithm or a variation thereof to find the second path.

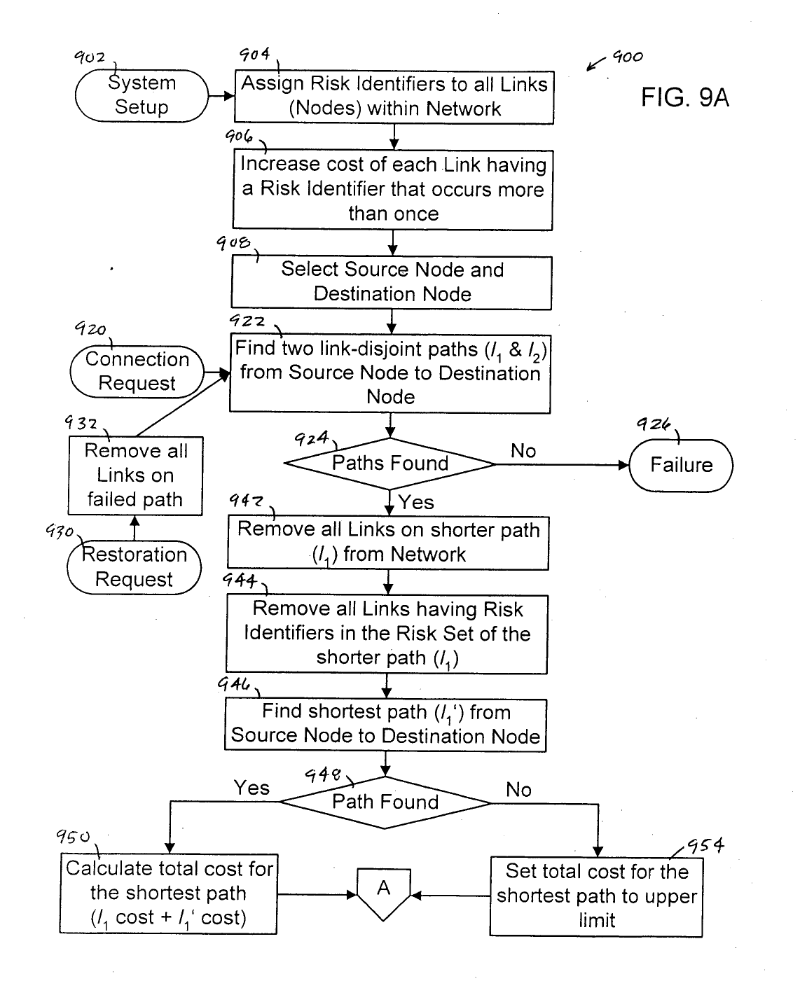

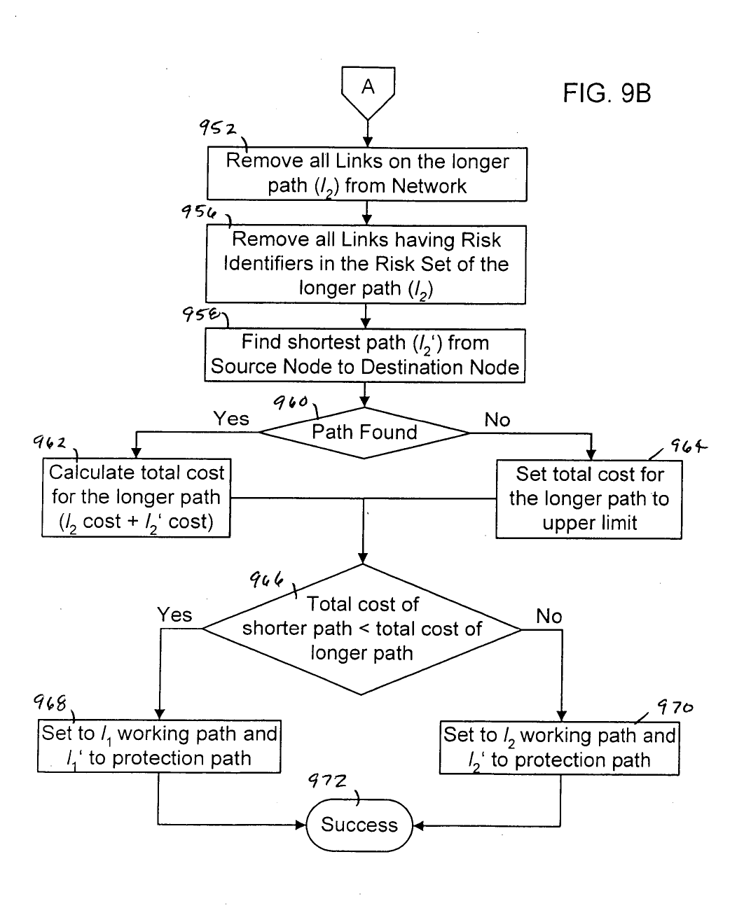

In yet another example, one embodiment of the present invention (FIGS. 9A and 9B) uses: (1) Suurballe's disjoint paths algorithm or a variation thereof to find two paths, the shorter of which is chosen as the first path and the longer of which is chosen as a third path; and (2) Dijkstra's shortest path algorithm or a variation thereof to find the second path. Thereafter, a total cost for the first path and the second path are calculated, the network model is modified by removing all links in the third path and all links having one or more risk identifiers in common with any of the risk identifiers of the links in the third path, a fourth path between the source node and the destination node is found using Dijkstra's shortest path algorithm or a variation thereof, and a total cost for the third path and the fourth path is calculated. The first path is provided as a working path and the second path is provided as a protection path whenever the total cost of the first path and the second path is less than or equal to the total cost of the third path and the fourth path. The third path is provided as the working path and the fourth path is provided as the protection path whenever the total cost of the first path and the second path is greater than the total cost of the third path and the fourth path.

The present invention can be used in any network, such as a computer network, a communications network, an electrical circuit, an electrical network, a logistics network or a pipeline network. Communications networks may include a mesh network, a ring network, an ATM network, an IP network, a MPLS network or an optical network. In addition, the present invention can embodied in a computer program embodied on a computer readable medium for finding two paths between a source node and a destination node in a network having multiple nodes and multiple links wherein each step is implemented as one or more code segments.

Three embodiments of the present invention (heuristic algorithms) for solving the dynamic path protection problem under the risk-disjoint constraint will now be described. The first heuristic is a Simple Two-Step algorithm similar to the one discussed above. In this algorithm, the cost of those links who's Risk ID appears more than once in the network is increased. The higher the link cost, the less likely that the link will be chosen by the first shortest path. Thus, when routing the second shortest path, there are more links available that are risk disjoint from the first shortest path. This approach increases the success rate of finding disjoint paths. Next, Dijkstra's shortest path algorithm is run to find the shortest path from the source to the destination. This path is designated as the working path. All the links that have common Risk IDs with the working path are then removed, including those links on the working path. Finally, Dijkstra's shortest path algorithm is rerun to obtain the next shortest path from the source to the destination and designate this path as the protection path.

Now referring to FIG. 7, a flow chart depicting of a method 700 for finding two paths between a source node and a destination node in a network having multiple nodes and multiple links in accordance with one embodiment of the present invention is shown. The method 700 has three entry points (system setup 702, connection request 720 and restoration request 740) and two exit points (return failure 726 and return success 752). When the system is initiated via system setup 702, risk identifiers are assigned to all links and/or nodes within the network in block 704. A risk identifier represents a factor that may cause the particular link to fail. Thereafter, the cost of each link and/or node having a risk identifier that occurs more than once in the network is increased in block 706. A source node and a destination node are then selected in block 708. Alternatively, the source node and the destination node can be received as part of a connection request in block 720.

Once the source and destination nodes are identified via block 708 or 720, a first path (shortest path) is found between the source node and the destination node using a routing algorithm (Dijkstra's shortest path algorithm or a variation thereof) and a model of the network in block 722. If the first path (shortest path) is not found, as determined in decision block 724, a failure notification is provided in block 726. If, however, a first path (shortest path) is found, as determined in decision block 724, the first path (shortest path) is set to the working path in block 728. Alternatively, the working path can be supplied as part of a restoration request wherein the working path is the failed path in block 740. The network model is modified by removing all links in the first path (working path) in block 742 and by removing all links having one or more risk identifiers in common with any of the risk identifiers of the links in the first path (working path) in block 744. A second path (shortest path) is then found between the source node and the destination node using the routing algorithm (Dijkstra's shortest path algorithm or a variation thereof) and the modified network model in block 746. If the second path (shortest path) is not found, as determined in decision block 748, a failure notification is provided in block 726. If, however, a second path (shortest path) is found, as determined in decision block 748, the second path (shortest path) is set to the protection path in block 728 and a success notification is provided in block 752. The success notification will typically be an appropriate response to the request that initiated the process, e.g., a response to a connection request (block 720) would contain the working path and the protection path, whereas a response to a restoration request (block 740) would contain the protection path.

The first path and second path can be lightpaths wherein all links in the first path have a first wavelength channel and all links in the second path have a second wavelength channel. Note that the first wavelength channel and the second wavelength channel can be the same. In addition, the protection path can be reserved as a backup resource for a single connection or multiple connections.

The Simple Two-Step algorithm's pseudo code is given below:

```
for all network links
{
  for all Risk ID rₗ that occurs more than once in the network
  {
    cₗ = cₗ + f(nᵣₗ − 1);
    // Increase its cost cₗ if a link l has Risk IDs that occur more than once
  in the network. nᵣₗ is the number of rₗ 's occurrences in the network.
  f( ) is a function returns positive value.
  }
}
//Find the first shortest path from s to d
if ( Dijkstra's shortest path algorithm(s, d) fails )
  return(failure);
else
{
  remove links on the first shortest path;
  remove links whose Risk IDs are contained in the Risk Set of the
  first path;
  //Find the second shortest path
  if ( Dijkstra's shortest path algorithm(s, d) fails )
  return(failure);
}
return( the two paths);
```

The Simple Two-Step algorithm fails in some network topologies because the first shortest path is obtained without considering the disjoint path being routed next. Suurballe's algorithm overcomes the problem by jointly routing both paths and minimizing the total cost. The second heuristic is a Modified Two-Step algorithm that combines the Two-Step algorithm and Suurballe's algorithm. In the first step, the cost of those links whose Risk ID appears more than once in the network is increased. Next, Suurballe's algorithm is run and two link disjoint paths from the source to the destination are obtained. Note that these two paths may not be risk disjoint. Out of the two paths, the shorter one is designated as the working path. All the links that have common Risk IDs with the working path, including those links on the working path, are then removed. Finally, Dijkstra's shortest path algorithm is run and the shortest path from the source to the destination is obtained and this path is designated as the protection path.

Referring now to FIG. 8, a flow chart depicting of a method 800 for finding two paths between a source node and a destination node in a network having multiple nodes and multiple links in accordance with another embodiment of the present invention is shown. The method 800 has three entry points (system setup 802, connection request 820 and restoration request 840) and two exit points (return failure 826 and return success 852). When the system is initiated via system setup 802, risk identifiers are assigned to all links and/or nodes within the network in block 804. A risk identifier represents a factor that may cause the particular link to fail. Thereafter, the cost of each link and/or node having a risk identifier that occurs more than once in the network is increased in block 806. A source node and a destination node are then selected in block 808. Alternatively, the source node and the destination node can be received as part of a connection request in block 820.

Once the source and destination nodes are identified via block 808 or 820, two link-disjoint paths are found between the source node and the destination node using a routing algorithm (Suurballe's algorithm or a variation thereof) and a model of the network in block 822. If the paths are not found, as determined in decision block 824, a failure notification is provided in block 826. If, however, the paths are found, as determined in decision block 824, the shortest path (first path) of the two paths found is set to the working path in block 828. Alternatively, the working path can be supplied as part of a restoration request wherein the working path is the failed path in block 840. The network model is modified by removing all links in the first path (working path) in block 842 and by removing all links having one or more risk identifiers in common with any of the risk identifiers of the links in the first path (working path) in block 844. A second path (shortest path) is then found between the source node and the destination node using a routing algorithm (Dijkstra's shortest path algorithm or a variation thereof) and the modified network model in block 846. If the second path (shortest path) is not found, as determined in decision block 848, a failure notification is provided in block 826. If, however, a second path (shortest path) is found, as determined in decision block 848, the second path (shortest path) is set to the protection path in block 828 and a success notification is provided in block 852. The success notification will typically be an appropriate response to the request that initiated the process, e.g., a response to a connection request (block 820) would contain the working path and the protection path, whereas a response to a restoration request (block 840) would contain the protection path.

The first path and second path can be lightpaths wherein all links in the first path have a first wavelength channel and all links in the second path have a second wavelength channel. Note that the first wavelength channel and the second wavelength channel can be the same. In addition, the protection path can be reserved as a backup resource for a single connection or multiple connections.

The Modified Two-Step algorithm's pseudo code is given below:

```
for all network links
{
  for all Risk ID rₗ that occurs more than once in the network
  {
    cₗ = cₗ + f(nᵣₗ − 1);
    // Increase its cost cₗ if a link l has Risk IDs that occur more than once
  in the network. nᵣₗ is the number of rₗ 's occurrences in the network. f( )
  is a function returns positive value.
  }
}
//Find two link disjoint paths from s to d
if ( Suurballe's disjoint paths algorithm(s, d) fails )
  return(failure);
else
{
  choose the shorter path obtained from Suurballe's algorithm and discard
the other;
  remove links on the first path;
  remove links whose Risk IDs are contained in the Risk Set of the first
  path;
  //Find the second path
  if ( Dijkstra's shortest path algorithm(s, d) fails )
  return(failure);
}
return( the two paths);
```

Compared to the Simple Two-Step algorithm, the Modified Two-Step algorithm is superior because it may find two disjoint paths in networks where the simple two-step algorithm fails. Compared to heuristics designed specifically for fiber span or duct-layer constraint, the Modified Two-Step algorithm works on network with arbitrary risk distribution, including configurations where a fiber link belongs to multiple spans thus has more than one Risk ID. If every Risk ID occurs only once in the network, this algorithm is equivalent to Suurballe's algorithm. The Modified Two-Step algorithm has the same order of time complexity as Suurballe's algorithm.

The third heuristic is an Improved Two-Step algorithm that better incorporates Suurballe's algorithm into the two heuristic algorithms developed for dynamic path protection under the wavelength continuity constraint. Also, load-balancing functionality may be added to the Modified Two-Step algorithm to achieve even lower blocking probability for dynamic path protection under the risk-disjoint constraint.

Now referring to FIGS. 9A and 9B, flow charts depicting of a method 900 for finding two paths between a source node and a destination node in a network having multiple nodes and multiple links in accordance with another embodiment of the present invention is shown. The method 900 has three entry points (system setup 902, connection request 920 and restoration request 930) and two exit points (return failure 926 and return success 972). When the system is initiated via system setup 902, risk identifiers are assigned to all links and/or nodes within the network in block 904. A risk identifier represents a factor that may cause the particular link to fail. Thereafter, the cost of each link and/or node having a risk identifier that occurs more than once in the network is increased in block 906. A source node and a destination node are then selected in block 908. Alternatively, the source node and the destination node can be received as part of a connection request in block 920. Similarly, the source node and the destination node can be received as part of a restoration request in block 930. A restoration request will also include the failed path so that the network model can be modified by removing all links on the failed path in block 932.

Once the source and destination nodes are identified via block 908 or 920 or 932, two link-disjoint paths (the shorter path designated l₁ (first path) and the longer path designated l₂ (third path)) are found between the source node and the destination node using a routing algorithm (Suurballe's algorithm or a variation thereof) and a model of the network in block 922. If the paths are not found, as determined in decision block 924, a failure notification is provided in block 926. If, however, the paths are found, as determined in decision block 924, the network model is modified by removing all links in the shortest path l₁ (first path) in block 942 and by removing all links having one or more risk identifiers in common with any of the risk identifiers of the links in the shorter path l₁ (first path) in block 944. A shortest path (designated as l₁′ (second path)) is then found between the source node and the destination node using a routing algorithm (Dijkstra's shortest path algorithm or a variation thereof) and the modified network model in block 946. If a path is found, as determined in decision block 948, the total cost for the shortest path (cost for l₁ (first path)+cost for l₁′ (second path)) is calculated in block 950 and the network model is modified by removing all links in the longer path l₂ (third path) in block 952. If, however, a path is not found, as determined in decision block 948, the total cost for the shortest path is set to an upper limit (e.g., ∞) in block 954 and the network model is modified by removing all links in the longer path l₂ (third path) in block 952.

The network model is then modified by removing all links having one or more risk identifiers in common with any of the risk identifiers of the links in the longer path l₂ (third path) in block 956. A shortest path (designated as l₂′ (fourth path)) is then found between the source node and the destination node using a routing algorithm (Dijkstra's shortest path algorithm or a variation thereof) and the modified network model in block 958. If a path is found, as determined in decision block 960, the total cost for the longer path (cost for l₂ (third path)+cost for l₂′ (fourth path)) is calculated in block 962. If, however, a path is not found, as determined in decision block 960, the total cost for the longer path is set to an upper limit (e.g., ∞) in block 964. After blocks 962 and 964, if the total cost of the shorter path (cost for l₁ (first path)+cost for l₁′ (second path)) is less than (or equal to) the total cost of the longer path (cost for l₂ (third path)+cost for l₂′ (fourth path)), as determined in decision block 966, path l₁ (first path) is set to the working path and path l₁′ (second path) is set to the protection path in block 968, and a success notification is provided in block 972. If, however, the total cost of the shorter path (cost for l₁ (first path)+cost for l₁′ (second path)) is greater than the total cost of the longer path (cost for l₂ (third path)+cost for l₂′ (fourth path)), as determined in decision block 966, path l₂ (third path) is set to the working path and path l₂′ (fourth path) is set to the protection path in block 970, and a success notification is provided in block 972. The success notification will typically be an appropriate response to the request that initiated the process, e.g., a response to a connection request (block 920) would contain the working path and the protection path, whereas a response to a restoration request (block 930) would contain the protection path.

The first path and second path can be lightpaths wherein all links in the first path have a first wavelength channel and all links in the second path have a second wavelength channel. Note that the first wavelength channel and the second wavelength channel can be the same. In addition, the protection path can be reserved as a backup resource for a single connection or multiple connections.

The Improved Two-Step alogrithm's pseudo code is given below:

for all network links

```
{
  for all Risk ID rₗ that occurs more than once in the network
  {
    cₗ = cₗ + f(nᵣₗ − 1);
    // Increase its cost cₗ if a link l has Risk IDs that occur more than once
  in the network. nᵣₗ is the number of rₗ 's occurrences in the network. f( )
  is a function returns positive value.
  }
}
//Find two link disjoint paths from s to d
if ( Suurballe's disjoint paths algorithm(s, d) fails )
  return(failure);
else
{
  choose the shorter path l₁ obtained from Suurballe's algorithm;
  remove links on the l₁ ;
  remove the links whose Risk IDs are contained in the Risk Set of l₁;
  if ( Dijkstra's shortest path algorithm(s, d) succeeds in finding path l₁′
from s to d)
    Total cost CT₁ = l₁ cost + l₁′ cost;
  else
    CT₁ = INFINITY;
    choose the longer path l₂ obtained from Suurballe's algorithm;
    remove links on the l₂ ;
    remove the links whose Risk IDs are contained in the Risk Set of l₂;
  if ( Dijkstra's shortest path algorithm(s, d) succeeds in finding path l₂′
from s to d)
    Total cost CT₂ = l₂ cost + l₂′ cost;
  else
    CT₂ = INFINITY;
    if (CT₁ < CT₂)
      assign l₁ to be the working path and l₁′ to be the protection
    path;
    else
      assign l₂ to be the working path and l₂′ to be the protection
    path;
  }
  return( the working path and the protection path);
```

Two problems on dynamic path protection in WDM mesh networks have been discussed. In the first problem, all lightpaths are subject to the wavelength continuity constraint. The objective is to find link-disjoint working and protection lightpaths, each on a different wavelength. In the second problem, wavelength conversion eliminates the wavelength continuity constraint but a single risk factor may cause multiple links or nodes to fail simultaneously. The objective is to find link disjoint working and protection lightpaths that are also risk disjoint. Both problems do not have constraint on the total cost of the two lightpaths. As proven above, the two problems are NP-complete. The second problem can be generalized to any connection-oriented network by using Risk IDs and Risk Sets. To solve these two NP-complete problems, the present invention provides an ILP formulation and three heuristic algorithms.

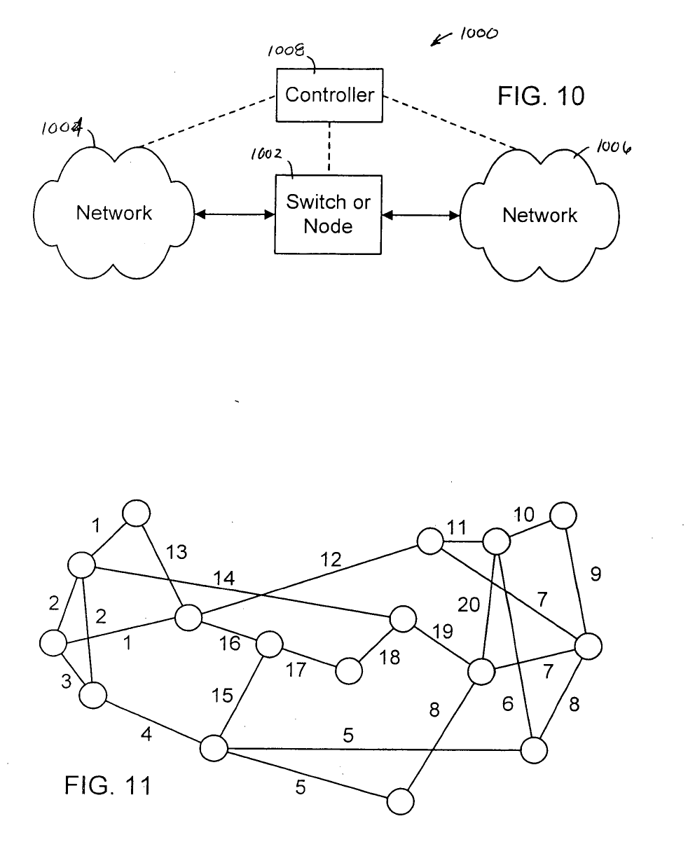

These three algorithms and the associated methods can be implemented as FIG. 10 depicts a block diagram of a system 1000 in accordance with one embodiment of the present invention. The system includes multiple nodes (e.g., 1002) and multiple links (solid links) within or between one or more networks 1004, 1006, and an apparatus, controller or processor 1008. Note that networks 1004 and 1006 could be a single network that includes switch or node 1002. Moreover, switch or node 1002 can be within network 1004 or network 1006 or be an interface between the two networks 1004 and 1006. Although only one link is shown between switch or node 1002 and networks 1004 and 1006, many such links may actually exist. Other networks may also connect to switch or node 1002 via one or more links. Each network 1004 and 1006 will contain its own topology of interconnect nodes and links. A source node and a destination node can be selected from switch or node 1002 or any node within network 1004 or network 1006. The apparatus, controller or processor 1008 has one or more communication interfaces communicably coupled to the switch or node 1002, network 1004 or network 1006 that are capable of communicating with the one or more networks. The apparatus, controller or processor 1008 can be part of the switch or node 1002, network 1004 or network 1006. The apparatus, controller or processor 1008 finds a first path between the source node and the destination node using a routing algorithm and a model of the one or more networks. Each link has a cost and at least one risk identifier. The cost of the links having one or more risk identifiers that occur more than once in the network model are increased. The network model is modified by removing all links in the first path and all links having one or more risk identifiers in common with any of the risk identifiers of the links in the first path. A second path is found between the source node and the destination node using the routing algorithm and the modified network model. The apparatus, controller or processor 1008 can use any of the methods described herein to determine the first path and the second path.

Computer simulations were conducted to evaluate the heuristic algorithms and compare their blocking probabilities under various traffic loads. More specifically, the computer simulations evaluate the performance of the four heuristic algorithms for the dynamic path protection routing problems, i.e., the Route-First and the Wavelength-Scan algorithms for networks with the wavelength continuity constraint, and the Simple Two-Step and the Modified Two-Step algorithms for networks with the risk-disjoint constraint. In these simulations, the primary performance metric is the blocking probability. The simulation reveals that, for the first problem, when network load is low, the Route-First algorithm performs better than the Wavelength-Scan algorithm. When network load is high, the Wavelength-Scan algorithm performs better than the Route-First algorithm. On the second problem, the Modified Two-Step algorithm always performs better than the Simple Two-Step algorithm. Its blocking probabilities are very close to those of an optimal solution without the risk-disjoint constraint.

Now referring to FIG. 11, the 16-node, 25-link NSFNET backbone topology is depicted that was used for the simulations. The cost of every link is assumed to be 1, and the capacity on each link is 8 units. Working paths and protection paths each take one unit of capacity. Connection requests arrive according to a Poisson process, and holding times are exponentially distributed. There is no requirement for working and protection paths to be node disjoint.

In the first simulation, the blocking probabilities of the Route-First algorithm and the Wavelength-Scan algorithm are compared. Recall that the Route-First algorithm first selects two link disjoint routes and then assigns free wavelengths to them. The Wavelength-Scan algorithm searches through all available free wavelengths for a pair of link disjoint routes. For each of the algorithms, the simulation run for an extended period of time, under various traffic loads, comparing their blocking probabilities. The results are depicted in FIGS. 12 and 13. More specifically, FIG. 12 depicts a graph of blocking probability versus load for the Route-First algorithm and the Wavelength-Scan algorithm under high loads in accordance with one embodiment of the present invention. FIG. 13 depicts a graph of blocking probability versus load for the Route-First algorithm and the Wavelength-Scan algorithm under low loads in accordance with one embodiment of the present invention.

The simulation shows that when the traffic load is low, the Route-First algorithm performs better than the Wavelength-Scan algorithm. When the traffic load is high, the Wavelength-Scan algorithm is slightly better than the Route-First algorithm. As was previously discussed, when the traffic load is low, free wavelengths are readily available, and the routes obtained from the Route-First algorithm are optimal in total cost. Therefore, the Route-First algorithm has lower blocking probabilities. When the traffic load becomes higher, the Wavelength-Scan algorithm has lower blocking probability because it searches through all available wavelengths. The simulation results match our expectation.

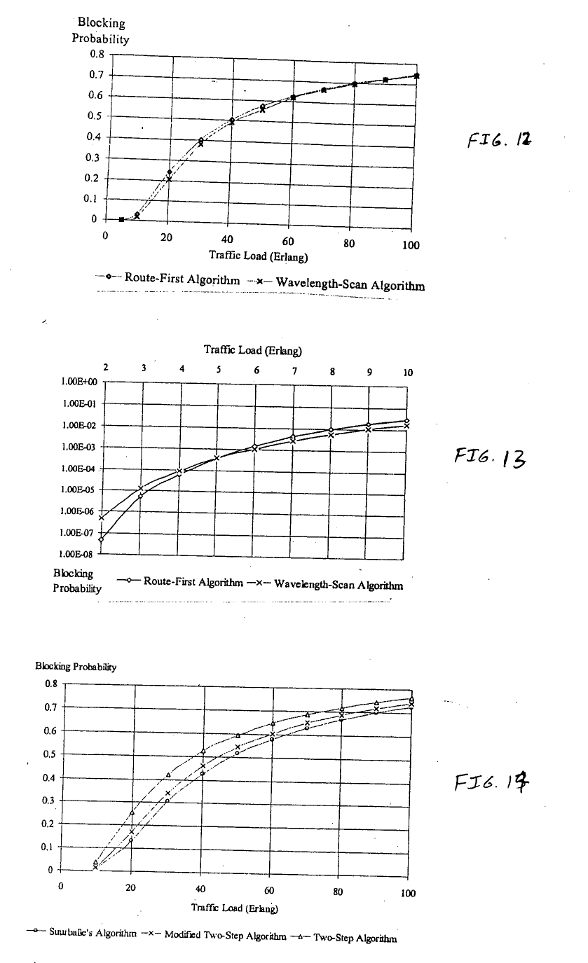

The next computer simulation is for the Simple Two-Step algorithm and the Modified Two-Step algorithm for networks with the risk-disjoint constraint. The network topology is the same as that in the previous simulation, but Risk IDs are assigned to the links. Full wavelength conversion at every node is assumed. Since an optimal solution is infeasible due to the NP-completeness of the problem, we run Suurballe's algorithm without the risk-disjoint constraint and use the resulting blocking probabilities as a lower bound to measure the effectiveness of the two heuristic algorithms. Note that the disjoint paths obtained from Suurballe's algorithm may not be risk disjoint. The simulation results are depicted in FIG. 14. More specifically, FIG. 14 depicts a graph of blocking probability versus load for the Simple Two-Step algorithm and the Modified Two-Step algorithm under low loads in accordance with one embodiment of the present invention.

The simulation results show that the blocking probabilities of the Modified Two-Step algorithm are up to 9% better than those of the Simple Two-Step algorithm, and up to 3% worse than the blocking probabilities of Suurballe's algorithm without the risk-disjoint constraint. The performance of the Modified Two-Step algorithm stems from its incorporation of Suurballe's algorithm and its effort to minimize the total cost of the working path and its disjoint path. Thus this algorithm is an effective solution for finding risk disjoint working path and its protection path.

Although preferred embodiments of the present invention have been described in detail, it will be understood by those skilled in the art that various modifications can be made therein without departing from the spirit and scope of the invention as set forth in the appended claims.

1. A method for finding two paths between a source node and a destination node in a network having multiple nodes and multiple links, the method comprising the steps of:
finding a first path between the source node and the destination node using a routing algorithm and a model of the network wherein each link has a cost and at least one risk identifier and the cost of the links having one or more risk identifiers that occur more than once in the network model are increased;
modifying the network model by removing all links in the first path and all links having one or more risk identifiers in common with any of the risk identifiers of the links in the first path; and
finding a second path between the source node and the destination node using the routing algorithm and the modified network model.

2. The method as recited in claim 1, wherein:
the steps of modifying the network model and finding the second path are only performed when the step of finding the first path is successful;
providing a first failure notification when the step of finding the first path is fails; and
providing a second failure notification when the step of finding the second path is fails.

3. The method as recited in claim 1, further comprising the steps of:
assigning the cost and the risk identifier(s) to each link; and
increasing the cost of each link having one or more risk identifiers that occur more than once in the network model.

4. The method as recited in claim 1, wherein each risk identifier represents a factor that may cause the link to fail.

5. The method as recited in claim 1, wherein the first path and second path are lightpaths, all links in the first path have a first wavelength channel and all links in the second path have a second wavelength channel.

6. The method as recited in claim 5, wherein the first wavelength channel and the second wavelength channel are the same.

7. The method as recited in claim 1, further comprising the step of selecting the source node and the destination node.

8. The method as recited in claim 1, further comprising the steps of:
receiving a connection request containing the source node and the destination node; and
providing the first path as a working path and the second path as a protection path.

9. The method as recited in claim 1, wherein the step of finding a first path between the source node and the destination node using a routing algorithm and the network model comprises the steps of:
receiving a restoration request containing a failed path such that the first path is the failed path; and
providing the second path as a restoration path.

10. The method as recited in claim 1, further comprising the step of providing the first path as a working path and the second path as a protection path.

11. The method as recited in claim 10, wherein the protection path is reserved as a backup resource for a single connection or multiple connections.

12. The method as recited in claim 1, wherein the routing algorithm is Dijkstra's shortest path algorithm or a variation thereof.

13. The method as recited in claim 1, wherein the routing algorithm is Suurballe's disjoint paths algorithm or a variation thereof.

14. The method as recited in claim 1, wherein:
the routing algorithm used to find the first path is Suurballe's disjoint paths algorithm or a variation thereof, which finds two paths, and the shorter of the two paths is chosen as the first path; and
the routing algorithm used to find the second path is Dijkstra's shortest path algorithm or a variation thereof.

15. The method as recited in claim 1, wherein:
the routing algorithm used to find the first path is Suurballe's disjoint paths algorithm or a variation thereof, which finds two paths, and the shorter of the two paths is chosen as the first path and the longer of the two paths is chosen as a third path; and
the step of finding the second path between the source node and the destination node using the routing algorithm and the modified network model comprises the steps of:
finding the second path between the source node and the destination node using the Dijkstra's shortest path algorithm or a variation thereof,
calculating a total cost for the first path and the second path,
modifying the network model by removing all links in the third path and all links having one or more risk identifiers in common with any of the risk identifiers of the links in the third path,
finding a fourth path between the source node and the destination node using the Dijkstra's shortest path algorithm or a variation thereof,
calculating a total cost for the third path and the fourth path,
providing the first path as a working path and the second path as a protection path whenever the total cost of the first path and the second path is less than or equal to the total cost of the third path and the fourth path, and,
providing the third path as the working path and the fourth path as the protection path whenever the total cost of the first path and the second path is greater than the total cost of the third path and the fourth path.

16. The method as recited in claim 14, wherein:
the steps of modifying the network model and finding the second path are only performed when the step of finding the first path is successful;
providing a first failure notification when the step of finding the first path is fails;
the step of calculating the total cost for the first path and the second path is only performed when the step of finding the second path is successful;
setting the total cost for the first path and the second path to an upper limit when the step of finding the second path is not successful; and
the step of calculating the total cost for the third path and the fourth path is only performed when the step of finding the fourth path is successful; and
setting the total cost for the third path and the fourth path to the upper limit when the step of finding the fourth path is not successful.

17. The method as recited in claim 1, further comprising the steps of:
assigning the cost and at least one risk identifier to each node within the network model;
increasing the cost of each node having one or more risk identifiers that occur more than once in the network model; and
the step of modifying the network model further comprises removing all nodes, except for the source node and the destination node, in the first path and all nodes, except for the source node and the destination node, having one or more risk identifiers in common with any of the risk identifiers of the nodes in the first path.

18. The method as recited in claim 1, wherein the network is a computer network, a communications network, an electrical circuit, an electrical network, a logistics network or a pipeline network.

19. The method as recited in claim 17, wherein the communications network is a mesh network, a ring network, an ATM network, an IP network, a MPLS network or an optical network.

20. A computer program embodied on a computer readable medium for finding two paths between a source node and a destination node in a network having multiple nodes and multiple links, the computer program comprising:
a code segment for finding a first path between the source node and the destination node using a routing algorithm and a model of the network wherein each link has a cost and at least one risk identifier and the cost of the links having one or more risk identifiers that occur more than once in the network model are increased;
a code segment for modifying the network model by removing all links in the first path and all links having one or more risk identifiers in common with any of the risk identifiers of the links in the first path; and
a code segment for finding a second path between the source node and the destination node using the routing algorithm and the modified network model.

21. An apparatus for finding two paths between a source node and a destination node in a network having multiple nodes and multiple links, the apparatus comprising:
a processor capable of finding a first path between the source node and the destination node using a routing algorithm and a model of the network wherein each link has a cost and at least one risk identifier and the cost of the links having one or more risk identifiers that occur more than once in the network model are increased, modifying the network model by removing all links in the first path and all links having one or more risk identifiers in common with any of the risk identifiers of the links in the first path, and finding a second path between the source node and the destination node using the routing algorithm and the modified network model; and
one or more communication interfaces communicably coupled to the processor that are capable of communicating with the network.

22. The apparatus as recited in claim 21, wherein the network is a computer network, a communications network, an electrical circuit, an electrical network, a logistics network or a pipeline network.

23. The apparatus as recited in claim 22, wherein the communications network is a mesh network, a ring network, an ATM network, an IP network, a MPLS network or an optical network.

24. A system comprising:
one or more networks having multiple nodes and multiple links;
a source node and a destination node within the one or more networks;
a processor capable of finding a first path between the source node and the destination node using a routing algorithm and a model of the one or more networks wherein each link has a cost and at least one risk identifier and the cost of the links having one or more risk identifiers that occur more than once in the network model are increased, modifying the network model by removing all links in the first path and all links having one or more risk identifiers in common with any of the risk identifiers of the links in the first path, and finding a second path between the source node and the destination node using the routing algorithm and the modified network model; and
one or more communication interfaces communicably coupled to the processor that are capable of communicating with the one or more networks.
